(19) United States
(12) Patent Application Publication
(10) Pub. No.: US 2024/0332931 A1
(43) Pub. Date: Oct. 3, 2024

(54) WIREWAY SEAL CAP FOR USE WITH AN ELECTRICAL BOX

(71) Applicant: J2 LIGHT INC., St. Albert (CA)

(72) Inventors: Jeff HAYMAN, St. Albert (CA); Jeremy MACGILLIVRAY, St. Albert (CA)

(73) Assignee: J2 LIGHT INC., St. Albert (CA)

(21) Appl. No.: 18/620,782

(22) Filed: Mar. 28, 2024

Related U.S. Application Data
(60) Provisional application No. 63/456,157, filed on Mar. 31, 2023.

(51) Int. Cl. H02G 3/08; F21V 31/00; F21Y 115/10

(52) U.S. Cl. CPC H02G 3/088; F21V 31/005; F21Y 2115/10

(57) ABSTRACT

In one aspect of the present invention a wireway seal cap for use with an electrical box is provided and comprises an outer surface for covering an opening within the electrical box. A male member extending from the outer surface of the seal cap for insertion in the opening of the electrical box is also provided and a lip surrounding the male member having an uneven portion allowing to secure the seal cap within the electrical box opening is provided on the wireway seal cap.

In another aspect of an invention a retrofit system for fluorescent fixtures is provided wherein the system allows to interchange the existing internal wiring configuration to a configuration having a driver with multiple functions controlling the power to a light source and other applications such as sensors.

### CROSS REFERENCE TO RELATED APPLICATION

The present application claims priority to U.S. Provisional Application No. 63/456,157, entitled “A RETROFIT SYSTEM FOR FLUORESCENT FIXTURES” filed on Mar. 31, 2023, the contents of which are incorporated herein by reference in their entirety.

### FIELD OF THE INVENTION

The present invention pertains to wireway seals and more specifically to a wireway seal cap which can be used to seal an opening in an electrical box or compartment.

### BACKGROUND OF THE INVENTION

There is a need for a wireway seal cap which can be used to properly seal an opening within an electrical box which box or compartment which box or compartment might be for a lighting apparatus. Specifically, there is a need for a wireway seal cap which has an even lip allowing the cap to confirm and overlap closed metal edges and abut along vertical edges of an electrical box or compartment.

In another invention within the present disclosure, a number of lighting fixtures in older buildings consist of fluorescent fixtures which use fluorescent lamps or old LED fixtures that are in a state of disrepair, inefficient, or limited to one color or one brightness. The use of fluorescent lamps is not energy efficient and converting existing fluorescent fixtures can be costly if the entire fixture needs to be removed from the ceiling for example. There is a need for a system which will use the existing fluorescent fixture while allowing to retrofit the fixture with more energy efficient lamps, sensors and programmable features such as light color, intensity and automation. Other benefits could be human centric such as less light intensity and more pleasing lighting leading to better overall health to individuals exposed to lighting of the present disclosure.

### SUMMARY OF THE INVENTION

The present invention provides a wireway seal cap for use with an electrical box comprising an outer surface for covering an opening within the electrical box. The wireway seal cap also has a male member extending from the outer surface of the seal cap for insertion in the opening of the electrical box; and a lip surrounding the male member having an uneven portion allowing to secure the seal cap within the electrical box opening.

The present disclosure also provides in another aspect a retrofit system for fluorescent fixtures comprising a driver for power management. The driver comprises a connection to power the driver as well as a power port for powering auxiliary components within the present system. The system also includes a power switch for controlling power to the lamps. The driver also has one or more light source outlets for powering one or more light sources and an antenna for remote control of the driver. The retrofit system of the present invention also has one or more light sources connected to the driver for providing illumination to an area.

The present disclosure also further provides in another aspect a converter for LED fixtures comprising three regions such as i) a power portal region; ii) an LED portal region and iii) a color portal region wherein the converter can communicate with a mobile application to program various features to the LED fixture.

### BRIEF DESCRIPTION OF TH DRAWINGS

The embodiments of the present invention will now be described by reference to the following figures, in which identical reference numerals in different figures indicate identical elements and in which:

FIG. 1 is a perspective view of the components of the retrofit system according to one embodiment of an invention with a sensor;

FIG. 2 is a perspective view of a driver having an LED lamp and sensor connected to the driver according to one embodiment of an invention;

FIG. 3 is a perspective view of a driver used in a retrofit system according to one embodiment of an invention;

FIG. 4 is a perspective view of a converter for converting an LED fixture into a programmable fixture according to one embodiment of another invention;

FIG. 5 is a perspective view of a converter without a cover as shown in FIG. 4 according to one embodiment of another invention;

FIG. 6 is a top view of a pair of wireway seal caps according to one embodiment of a further invention;

FIG. 7 is a side view of a pair of wireway seal caps according to one embodiment of a further invention;

FIG. 8 is another side view of a pair of seal caps according to one embodiment of a further invention;

FIG. 9 is an underside perspective view of a pair of seal caps according to one embodiment of a further invention;

FIG. 10 is a top view of an electrical box having openings to be sealed by seal caps according to one embodiment of a further invention;

FIG. 11 is a top view of an electrical box having two seal caps sealing two openings on an electrical box according to one embodiment of a further invention;

FIG. 12 is a cut-away view as shown in FIG. 11 showing two seal caps installed within an electrical box according to one embodiment of a further invention; and,

FIG. 13 is a cut away view as shown in FIG. 11 showing a seal cap positioned on an electrical box according to one embodiment of a further invention.

The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention.

### DETAILED DESCRIPTION OF THE INVENTION

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. “Coupled” may be used to indicate that two or more elements are in either direct or indirect (with other intervening elements between them) physical or electrical contact with each other, or that the two or more elements co-operate or interact with each other (e.g. as in a cause and effect relationship).

The present invention includes a retrofit system for fluorescent fixtures comprising a driver for power management with the driver comprising:
i) a power connection to power the driver;
ii) a power option port for powering auxiliary components;
iii) a power switch for controlling power to the lamps;
iv) one or more light source outlets for powering light sources;
v) an antenna for remote control of the driver; and
vi) an input port to connect to light control motion/photo sensor

The retrofit system further comprises one or more light sources interconnected to the driver for providing illumination to an area. A fluorescent fixture is typically an inverted trough serving as a support and reflector usually for a fluorescent lighting unit. Other fixtures can accommodate the present system. The present retrofit system allows to remove the entire wiring system used to power fluorescent lamps and install LED lamps. The present system can also be used with minimal removal of existing wiring or based on the preference of the technician installing the system according to the present disclosure The present invention can also be used for all styles of fluorescent fixtures and is not limited to inverted troughs.

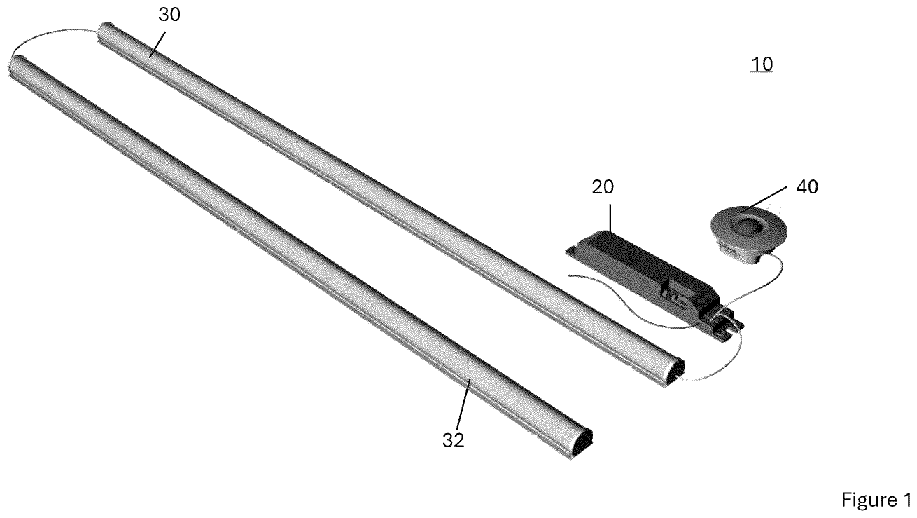

With reference to FIG. 1 and according to one embodiment of the present invention, a retrofit system 10 is shown having a driver 20 with LED lamp 30 connected to driver 20. A further LED lamp 32 is connected to LED lamp 30 which allows to provide power to LED lamp 32. The LED lamps 30 and 32 are light sources connected to the driver as would be used in the present invention. Lamps 30 and 32 have power ports at each end of the lamps which allows to connect two lamps or more in series if so desired in a specific application. Lamps 30 and 32 also encompass multiple colored LED within the lamp allowing for a smooth color choice by the user. The LED colors can be changed through the use of the wireless application controlling driver 20. The lamps used in the present system can be independently connected to driver 20 or can be connected in series depending the application desired. In an application having all lamps connected to driver 20, driver 20 is modified to include enough ports to connect the desired number of lamps. The power being fed to LED lamps can be split in two allowing to control the warm and cool lights independently which in turns allows for color mixing through a remote application.

The connections between the LED lamp 30 and driver 20 consist of connections as would be known by a worker skilled in the relevant art.

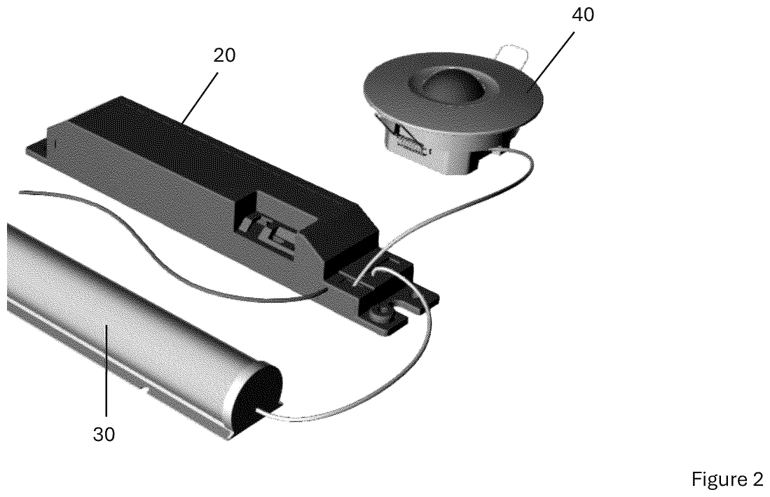

With reference to FIGS. 1 and 2 and according to one embodiment of the present invention, a motion sensor 40 can also be present within the present retrofit system. Sensor 40 is connected directly to the driver 20 allowing sensor 40 to activate the LED lamps when movement is detected or to adjust the lighting level when natural light increases or decreases. Sensor 40 could also be a photo sensor or a combination of a motion and photo sensor all in one sensor. Sensor 30 can be programmed and/or controlled through the driver which driver can be controlled by a wireless application.

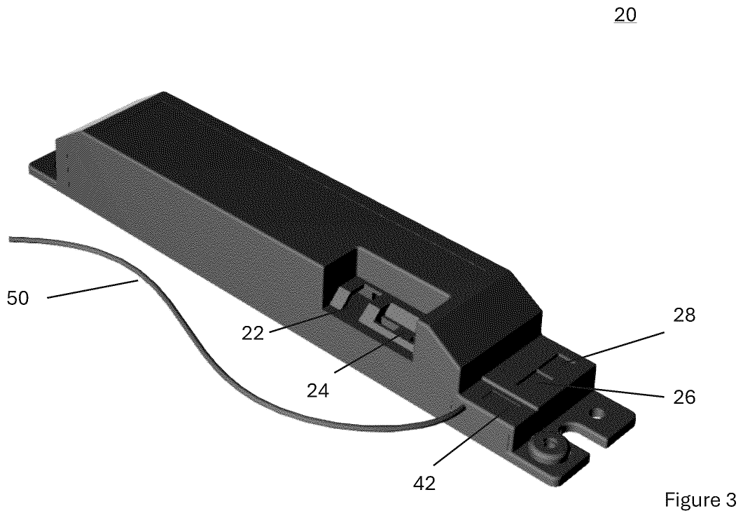

With reference to FIG. 3 and according to one embodiment of the present invention, a driver 20 is shown. Driver 20 has a power option port 22 for powering auxiliary components within the present system such as real time clock for example. Port 22 can consist of poke through connections as would be known by a worker skilled in the relevant art. The specific parameters of port 22 allow for low voltage to be emitted to one or more auxiliary components.

A power connection (not shown) is also present on driver 20 which can consist of any connection allowing to connect power from a driver to an existing power line within a building. The driver can be configured for various power settings such as 120 through to 347V rendering the system universal for all applications regardless of the voltage. In another embodiment, the drive can automatically adjust based on the power being fed to the driver. The power source is typically the building power or available power in the building which were already present within the fluorescent fixture having the present retrofit system installed into it.

With further reference to FIG. 3 and according to one embodiment of the present invention, driver 20 has power switch 24 allowing for the selection of an applicable power setting which could be consist of the following settings: 750/600/450 mA for example. The driver 20 of the present invention could be modified to have different power settings than described above. Driver 20 also has light source outlets 26 and 28 allowing for LED lamps (not shown) to be connected to the driver.

With further reference to FIG. 3 and according to one embodiment of the present invention, driver 20 can also include a sensor port 42 allowing for a sensor to be connected to the driver. One or more sensor ports could be included with driver 20. The driver can also have a reset button (not shown) allowing to unpair the driver with a wireless system. The driver can be configured to add other ports allowing to connect other applications such as sensors for daylight, or any other type of port needed for a specific type of application requiring a port. Other sensors could be connected to a port of the driver for sensing humidity, heat, smoke or any other desired measurement which can be measured or monitored by a sensor.

With further reference to FIG. 3 and according to one embodiment of the present invention, driver 20 can also include an antenna 50 allowing remote control of the driver by a user. Antenna 50 can connect to a phone for example allowing a user to activate or deactivate the driver which in turn would turn off the LED lamp or lamps within the retrofitted fluorescent fixture. The present application is not limited to a phone but rather any wireless control system which allows to activate, deactivate, modify or vary the lighting emitted from an LED lamp.

The driver and LED lamp used in the present invention can also have a magnetic underside allowing to position the driver and LED lamp within a fluorescent fixture. The use of the magnetic underside can be sufficient to secure either the drive or LED lamp within the fluorescent fixture. Screws (not shown) could also be used to further secure either the driver or LED lamp within the fluorescent fixture. The use of screws or any other fastener method would need to be compliant with any applicable codes wherein the present retrofit system is installed.

The present invention also describes a method for installing a retrofit system. The method consists of the following steps:
1) Turning off the power to a fluorescent fixture wherein the present retrofit system will be installed;
2) Removing the lens from the fluorescent fixture if one is present;
3) Removing the lamps present in the fluorescent fixture;
4) Removing the ballast cover if present in the fluorescent fixture;
5) Disconnecting the internal power lines connected in the fluorescent fixture;
6) Removing the existing ballast (only if required by local regulations) if present in the fluorescent fixture;
7) Positioning the driver within the fluorescent fixture;
8) Connecting power to the driver in the fluorescent fixture;
9) Selecting the power setting on the power switch as required for the lamp(s);
10) Connecting one or more LED lamp connection wires to the driver;
11) Assuring the antenna is clear of driver prior to reinstalling ballast cover to assure antenna is functional;
12) connect the sensor port and/or auxiliary power port as applicable;
13) Installing the ballast cover while assuring the LED lamp connection wires and the antenna are present outside of the ballast cover;
14) Connecting an LED lamp to one of the LED lamp connection wires connected to the driver;
15) Adding motion/daylight sensors and auxiliary devices as applicable; and
16) Installing the leans on the fluorescent fixture.

Other steps within this method could include further securing the driver and LED lamp within the fluorescent fixture through the use of screws or any other type of fixing measure as would be known in the industry for example.

Another step could also include the connection of a sensor to the driver prior to reinstalling the ballast cover. This step would include the connection of a connection wire between the driver and the sensor.

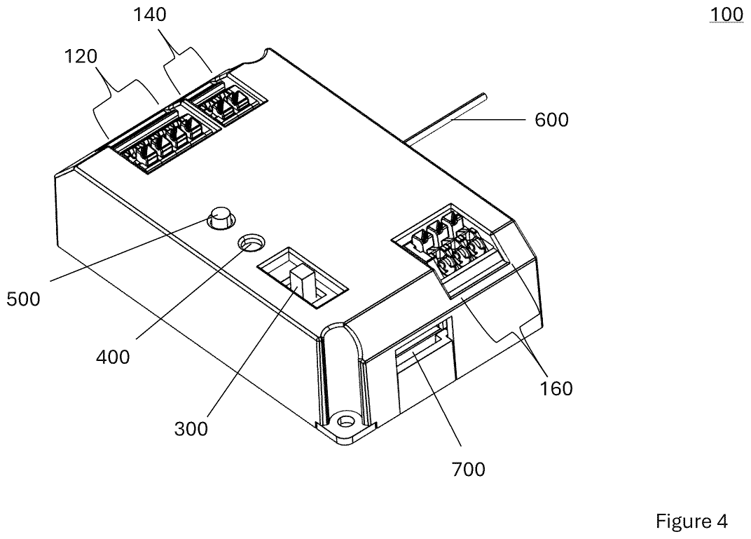

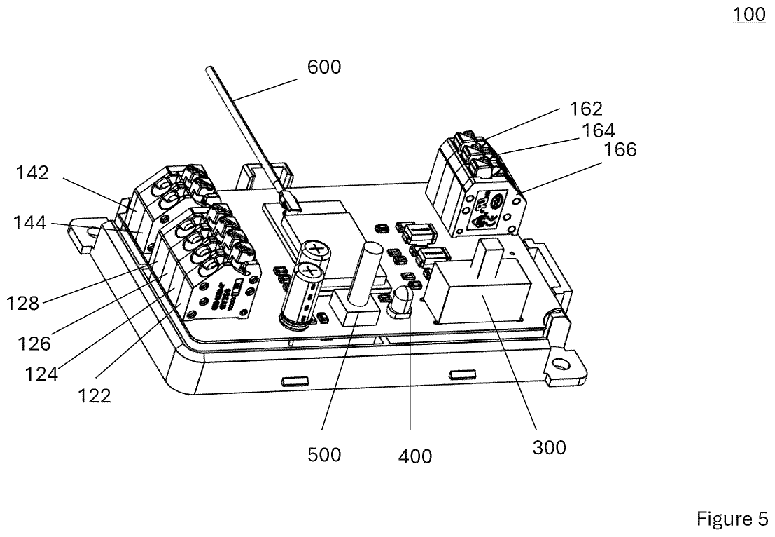

With reference to FIGS. 4 and 5 and according to one embodiment of another invention is shown as converter 100. Converter 100 can convert common LED fixtures having the basic on/off feature with either white or colored illumination into programmable fixtures through the use of a mobile software application. Converter 100 can be positioned on an LED fixture (not shown) through the use of magnets (not shown) positioned on the underside of converter 100. Any other type of fastening method can be used as long as the converter can be secured to a surface of an LED fixture. Converter 100 has three main portal regions which are power portal 120, an LED portal 140 and a color portal 160. Each portal region and their features will be further described below.

With further reference to FIGS. 4 and 5 and according to one embodiment of the present invention, converter 100 has power portal region 120 having ports 122, 124, 126 and 128. Ports 128 and 126 are ports allowing for connection to drivers having a separate 0-10V DC circuit which are commonly found in drivers used in LED fixtures. If such a driver is present in the LED fixture being converted then power lines which are grey (or pink as applicable) and purple are connected into ports 128 and 126. Ports 128 and 126 would be identified to allow a user to properly connected the purple and grey wires to the present converter.

With further reference to FIGS. 4 and 5 and according to one embodiment of the present invention, power portal region 120 also has ports 122 and 124 allowing for connection to a 12V auxiliary present on certain drivers found in LED fixtures. Ports 122 and 124 are clearly identified as being the proper ports for connection to a 12V auxiliary present in drivers. A transformer (not shown) can be used if the driver positioned in the LED fixture being converted does not include a 12V auxiliary connection. If a transformer is required the interconnectivity between the driver and the converter would be through ports 122 and 124.

With further reference to FIGS. 4 and 5 and according to one embodiment of the present invention, converter 100 has two ports in LED portal region 140. Ports 142 and 144 allow for interconnectivity to the driver wires providing power to LED modules/lights (not shown). In a typical LED fixture the driver would be connected to the LED modules. The current converter is positioned in between the driver and the LED modules by connecting the LED wires from the driver ((one being + and the other being −) into ports 142 and 144. Certain drivers may have up to three LED wires such as two being negative (−) and one positive (+). When such drivers are encountered both negative wires can be connected to a port within the LED portal region 140. Ports 142 and 144 would be defined as being either for (−) negative or (+) positive wires and their precise location is not important to the functioning of converter 100 as long as such ports allow for such connections with a driver in an LED fixture.

With further reference to FIGS. 4 and 5 and according to one embodiment of the present invention, converter 100 has ports 162, 164 and 166 in Color portal region section 160. Such ports allow for control of the power sent to the LED modules present in the LED fixture being converted with the addition of converter 100. The use of three ports allow to provide a programmable feature such as variable colors or simple white—mono color. If a single color is required then a single wire is connected in the Warm LED port 162 regardless of the color of the LEDs with another wire connected into port 166 (Cool LED+). If two colors are preferred then a wire is connected into ports 162 (Warm LED−) and 164 (Cool LED+).

With further reference to FIGS. 4 and 5 and according to one embodiment of the present invention, converter 100 has a switch 300 allowing to set the converter into two configurations which is either mono color or programmable. Based on the preferred configuration, switch 300 is set accordingly. Switch 300 can be any type of switch allowing a two-state configuration. In another embodiment switch 300 could be a switch allowing more than two states.

With further reference to FIGS. 4 and 5 and according to one embodiment of the present invention, converter 100 has an indicator light 400 which indicates when converter 100 is in an active state. An activate state can consist of indicating power is being communicated to the LED modules and/or when the converter is communicating with a mobile app allowing for the color of the LED modules to be varied as requested in an environment having LED modules.

With further reference to FIGS. 4 and 5 and according to one embodiment of the present invention, converter 100 has a reset switch 500 allowing to reset converter 100 if communication cannot be established with a mobile application. Converter 100 also has a wireless antenna 600 allowing communication with mobile applications to program the LED modules. Communication with a mobile application is not limited to an antenna and can be any other known manner of communicating wirelessly with a mobile application.

With reference to FIG. 4 and according to one embodiment of the present invention, converter 100 has an auxiliary port 700 allowing for the connection of sensors (not shown). Such sensors can be motion, daylight or any other sensors as would be applicable in a lighting environment. Port 700 can be configured based on the required number of wires to connected sensors to converter 100.

A retrofit system for fluorescent fixtures comprising: a) a driver for power management comprising: i) a power connection to power the driver; ii) a power option port for powering auxiliary components; iii) a power switch for controlling power to the lamps; iv) one or more light source outlets for powering light sources; and v) an antenna for remote control of the driver and b) one or more light sources connected to the driver for providing illumination to an area.

A converter for LED fixtures comprising a) a power portal region; b) an LED portal region; and c) a color portal region wherein the converter can communicate with a mobile application to program various features to the LED fixtures.

A person understanding this invention may now conceive of alternative structures and embodiments or variations of the above all of which are intended to fall within the scope of the invention as defined in the claims that follow.

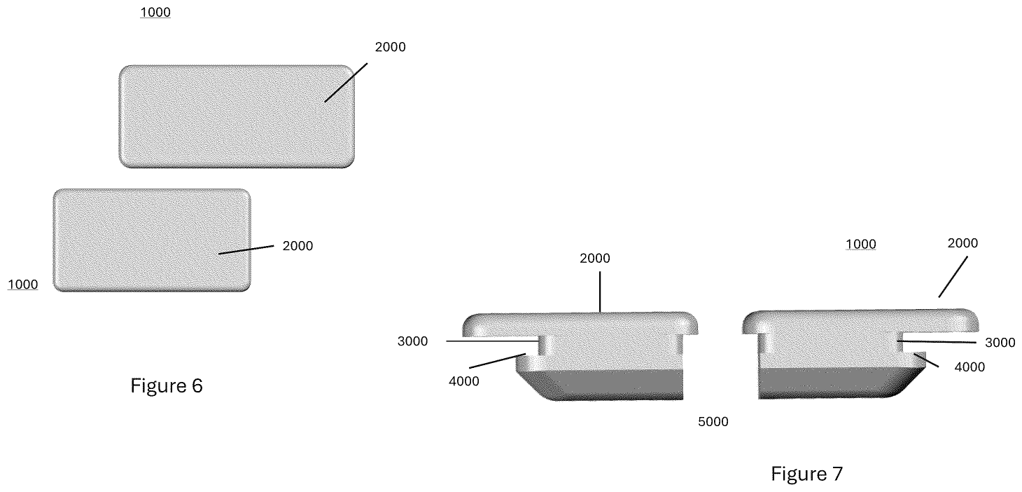

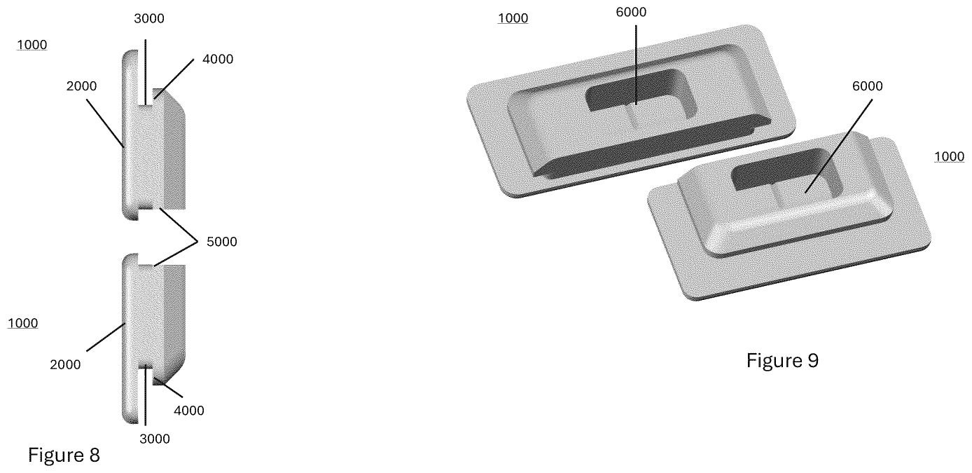

With reference to FIGS. 6-9 and according to one embodiment of a further invention, a wireway seal caps 1000 are shown. Seal caps 1000 have an outer surface 2000 which allows to cover openings present in an electrical box for example. Seal cap 1000 has a male member 3000 which extends from outer surface 2000 which member 3000 can be inserted through an opening of an electrical box. Seal cap 1000 also has a lip 4000 which has an uneven portion 5000 which allows to secure cap 1000 to an electrical box. The seal cap 1000 can also be referenced as a wireway seal cap without being outside the scope of the present invention.

With specific reference to FIG. 9 and according to one embodiment of the present invention, seal cap 1000 can also have a hollow space 6000 which hollow space can allow for the insertion of a wire through seal cap 1000 which creates the wireway of the present cap. The presence of hollow space 6000 allows to connect a wire for example within the electrical box and to a fixture which is within a large enclosure having the electrical box. The material used to fabricate a cap of the present invention is any suitable material which is flexible and can be perforated allowing for the passage of a wire. The wireway also allows for protection of the wire being passed through said hollow space by isolating the wire from the metal edges of openings within the electrical box 10.

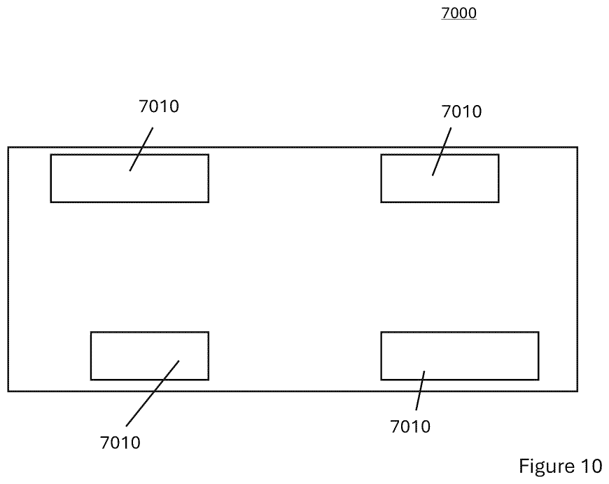

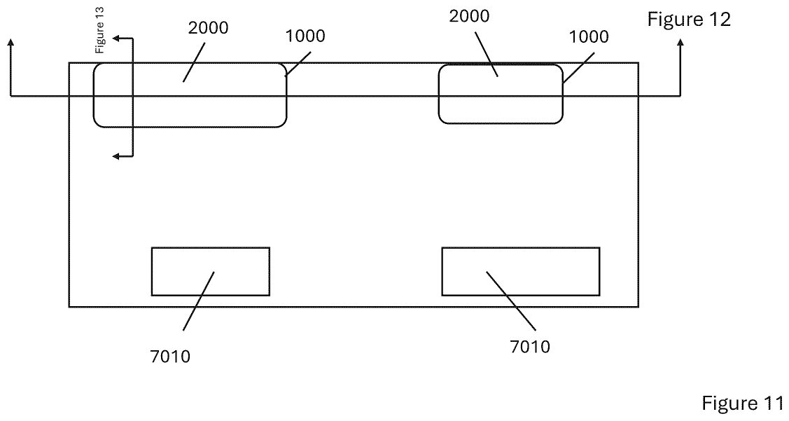

With reference to FIGS. 10 and 11 and according to one embodiment of the present invention, seal caps 1000 are installed within an electrical box 7000 having openings 7010. The number of openings within electrical box 7000 can vary and has no impact on the seal cap of the present invention. With further reference to FIG. 11 and according to one embodiment of the present invention, seal cap 1000 are positioned on electrical box 7000 with the seal cap 1000 completely covering opening 7010. The outer surface 2000 of seal cap 1000 provides the required cover to assure the entire opening is covered allowing to seal the opening.

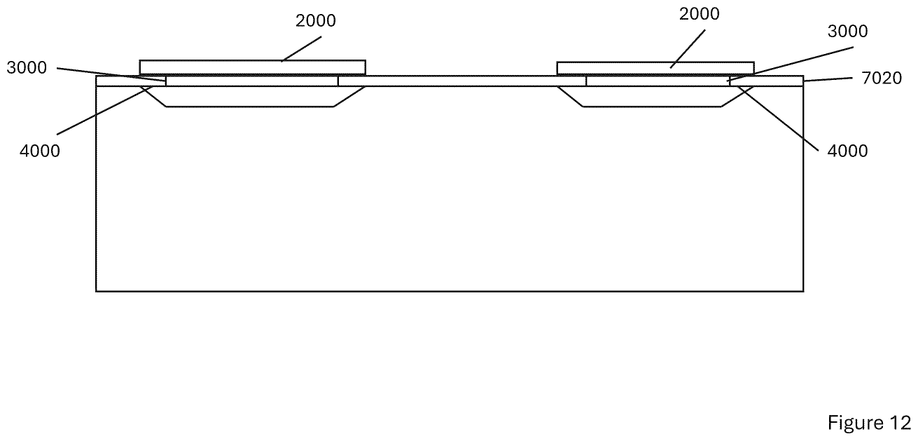

With reference to FIG. 12 and according to one embodiment of the present invention, outer surface 2000 of seal cap is positioned on electrical box 7000 wherein male member 3000 completely passes through openings within the electrical box 7000. Lip 4000 abuts against the outer wall 7020 of electrical box 7000 providing a seal of said opening within electrical box 7000.

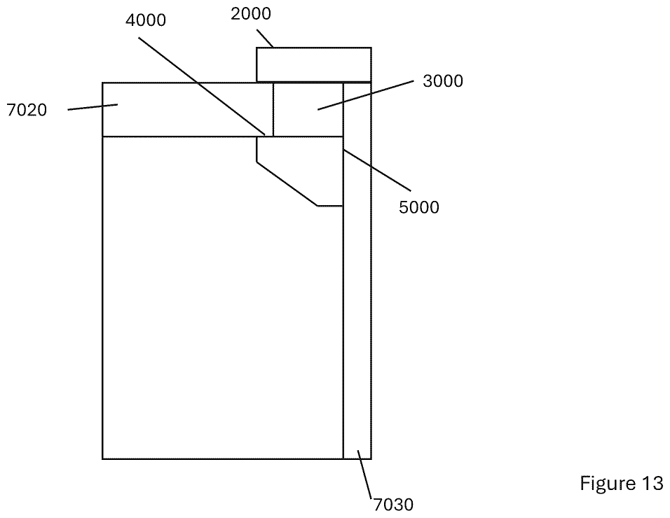

With reference to FIG. 13 and according to one embodiment of the present invention, seal cap 1000 is shown with lip 4000 sealing with outer wall 7020 of electrical box 7000 and uneven lip 5000 also sealing with outer wall 7030 of electrical box 7000. Uneven lip 5000 in combination with outer surface 2000 allows to seal an opening within an electrical box wherein the openings are along the edge of an electrical box. If lip 4000 was even along the entire perimeter of the male member 3000 present on a seal cap it would not allow for proper sealing of an opening as shown in FIGS. 11-13.

The length, width and depth of the present seal cap can vary and be dimensioned based on the size of the opening to be sealed for example. Male member extending from a seal cap will be the length of the thickness of a wall of an electrical box.

A wireway seal cap for use with an electrical box comprising:
a) An outer surface for covering an opening within the electrical box;
b) A male member extending from the outer surface of the seal cap for insertion in the opening of the electrical box; and,
c) A lip surrounding the male member having an uneven portion allowing to secure the seal cap within the electrical box opening.

A wireway seal cap further comprising a hollow space within the male member.

A wireway seal cap further comprising a pierceable surface within the hollow space to allow a passage of a wire.

A wireway seal cap further comprising a slopping edge along the lip.

A wireway seal cap wherein the male member is uncentered onto a back surface of the outer surface.

A wireway seal cap wherein the uneven lip is limited to a single edge of the male member.

A wireway seal cap wherein the uneven lip has a flat surface.

A wireway seal cap wherein the uneven lip is flush with at least one edge of the opening in the electrical box.

A wireway seal cap the uneven lip is flush with at least two parallel edges of the opening in the electrical box.

A wireway seal cap wherein the outer surface is wider than a width of the male member.

A person understanding this invention may now conceive of alternative structures and embodiments or variations of the above all of which are intended to fall within the scope of the invention as defined in the claims that follow.

What is claimed is:

1. A wireway seal cap for use with an electrical box comprising:
a) An outer surface for covering an opening within the electrical box;
b) A male member extending from the outer surface of the seal cap for insertion in the opening of the electrical box; and,
c) A lip surrounding the male member having an uneven portion allowing to secure the seal cap within the electrical box opening.

2. A wireway seal cap according to claim 1 further comprising a hollow space within the male member.

3. A wireway seal cap according to claim 2 further comprising a pierceable surface within the hollow space to allow a passage of a wire.

4. A wireway seal cap according to claim 1 further comprising a slopping edge along the lip.

5. A wireway seal cap according to claim 1 wherein the male member is uncentered onto a back surface of the outer surface.

6. A wireway seal cap according to claim 1 wherein the uneven lip is limited to a single edge of the male member.

7. A wireway seal cap according to claim 6 wherein the uneven lip has a flat surface.

8. A wireway seal cap according to claim 7 wherein the uneven lip is flush with at least one edge of the opening in the electrical box.

9. A wireway seal cap according to claim 7 wherein the uneven lip is flush with at least two parallel edges of the opening in the electrical box.

10. A wireway seal cap according to claim 1 wherein the outer surface is wider than a width of the male member.
